(19) United States
(12) Patent Application Publication
(10) Pub. No.: US 2023/0143259 A1
(43) Pub. Date: May 11, 2023

(54) AUTOMATIC ANALYZING APPARATUS

(71) Applicant: Canon Medical Systems Corporation, Otawara-shi (JP)

(72) Inventors: Tomohiro SUGIMURA, Otawara (JP); Shozo HASHIMOTO, Nasushiobara (JP); Takashi GOTO, Nasushiobara (JP); Masahiro MASUBUCHI, Yaita (JP); Yasuo AKIZAWA, Nasushiobara (JP)

(73) Assignee: Canon Medical Systems Corporation, Otawara-shi (JP)

(21) Appl. No.: 18/054,167

(22) Filed: Nov. 10, 2022

(30) Foreign Application Priority Data
Nov. 11, 2021 (JP) 2021-184163

(51) Int. Cl. G01N 35/10; G01N 35/02

(52) U.S. Cl. CPC G01N 35/1002; G01N 35/025; G01N 35/1004

(57) ABSTRACT

According to one embodiment, an automatic analyzing apparatus includes a feeder and a mixer unit. The feeder is configured to feed a first liquid and a second liquid. The mixer unit includes an inflow part, an internal space, and an outflow part. The mixer unit is configured so that the first liquid and the second liquid fed from the feeder enter through the inflow part, the first liquid and the second liquid entering through the inflow part flow inside the internal space, and the first liquid and the second liquid flowing inside the internal space exit through the outflow part according to an inflow entering through the inflow part.

### CROSS-REFERENCE TO RELATED APPLICATION

This application is based upon and claims the benefit of priority from the prior Japanese Patent Application No. 2021-184163, filed Nov. 11, 2021, the entire contents of which are incorporated herein by reference.

### FIELD

Embodiments described herein relate generally to an automatic analyzing apparatus.

### BACKGROUND

An automatic analyzing apparatus is employed in a variety of tests including a biochemical test, an immunological test, a blood coagulation test, and so on, where it optically measures color changes, turbidity transitions, etc., caused by a sample reacting with a reagent used for analysis in an individual test item. With an automatic analyzing apparatus, analysis data expressed as concentrations, enzyme activities, or other properties of the respective test-item ingredients contained in samples can be acquired based on measurement results.

Such an automatic analyzing apparatus is adapted to dispense a sample and a reagent into a reaction container by use of one or more probes, conduct measurement by irradiating the reaction liquid formed of the sample and the reagent in the reaction container with light, and wash the probes after dispensing operations and the reaction container after measurement so that they are used repeatedly. To wash components of probes and reaction containers which contact a sample and/or a reagent, a washing liquid containing a powerful detergent component is used. For example, in a method that uses such a washing liquid for washing reaction containers, a concentrated liquid containing a high concentration of a detergent component is diluted with a diluent to obtain the washing liquid, and the obtained washing liquid is used for washing.

Here, the concentrated liquid and the diluent are fed through different flow paths so as to join together in a given channel, where the concentrated liquid is diluted to provide the washing liquid for use in washing. However, this method does not guarantee a constant concentration of the detergent component for individual washing steps, which could lead to a poor capability to wash reaction containers due to the washing liquid having a reduced detergent component concentration, or to an undesired influence on the reaction of the reaction liquid due to a subtle amount of the detergent component remaining in the reaction container due to the washing liquid having an increased detergent component concentration. Consequently, conducting measurement with a reaction liquid may produce a problem of degraded analysis data.

### BRIEF DESCRIPTION OF THE DRAWINGS

FIG. 1 is a block diagram showing a configuration of an automatic analyzing apparatus according to an embodiment.

FIG. 2 is a perspective view showing an exemplary structure of an analyzer section according to the embodiment.

FIG. 3 is a diagram showing a configuration of a washer according to the embodiment.

FIG. 4 is a diagram showing a configuration of a first washing member according to the embodiment.

FIG. 5 is a diagram showing a configuration of a second washing member according to the embodiment.

FIG. 6 is a diagram showing an exemplary structure of a mixer unit according to the embodiment.

FIG. 7 is a diagram showing another exemplary structure of the mixer unit according to the embodiment.

FIG. 8 is a diagram showing a configuration of a third washing member according to the embodiment.

FIG. 9 is a diagram showing a configuration of a fourth washing member according to the embodiment.

FIG. 10 is a diagram showing a configuration of a drain member according to the embodiment.

FIG. 11 is a diagram showing a configuration of another washer according to the embodiment.

FIG. 12 is a diagram showing a structure of a washing bath according to the embodiment.

### DETAILED DESCRIPTION

In general, according to one embodiment, an automatic analyzing apparatus includes a feeder and a mixer unit. The feeder is configured to feed a first liquid and a second liquid. The mixer unit includes an inflow part, an internal space, and an outflow part. The mixer unit is configured so that the first liquid and the second liquid fed from the feeder enter through the inflow part, the first liquid and the second liquid entering through the inflow part flow inside the internal space, and the first liquid and the second liquid flowing inside the internal space exit through the outflow part according to an inflow entering through the inflow part.

Embodiments will be described with reference to the drawings.

In one embodiment, a feeder and a mixer unit are provided. The mixer unit includes an inflow part, an internal space, and an outflow part. The feeder feeds a first liquid and a second liquid. The first liquid and the second liquid fed from the feeder enter through the inflow part. The first liquid and the second liquid that have entered through the inflow part flow inside the internal space. The first liquid and the second liquid that have flown inside the internal space exit through the outflow part according to an inflow entering through the inflow part.

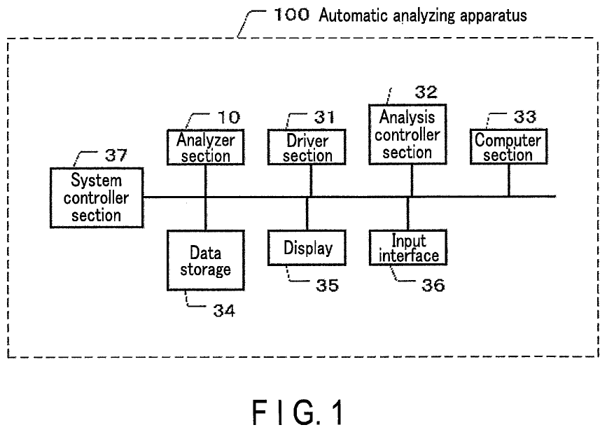

FIG. 1 is a block diagram showing a configuration of an automatic analyzing apparatus according to the embodiment. The description will assume that the automatic analyzing apparatus is intended for biochemical tests, immunological tests, and blood coagulation tests.

The automatic analyzing apparatus, denoted by reference number “100”, includes an analyzer section 10 for dispensing a sample such as a standard sample provided for an intended test item or a subject sample, and a reagent for the test item, and analyzing each sample by subjecting a reaction liquid containing the sample and the reagent to measurement operations. The automatic analyzing apparatus 100 also includes a driver section 31 for driving multiple components in the analyzer section 10 to perform dispensing operations, etc. for each sample and each reagent.

Also, the automatic analyzing apparatus 100 includes an analysis controller section 32 for controlling the driver section 31 to operate each component in the analyzer section 10. The automatic analyzing apparatus 100 includes a computer section 33 for preparing a calibration curve for each test item from standard data that has been generated by the analyzer section 10 through measurement of a reaction liquid containing a standard sample provided for the corresponding test item and a reagent for the test item, and for generating analysis data for the test item from subject data that has been generated through measurement of a reaction liquid containing a subject sample and the reagent for the test item. The automatic analyzing apparatus 100 includes a data storage 34 for storing calibration curves, analysis data, etc., obtained at the computer section 33.

The automatic analyzing apparatus 100 includes a display 35 for presenting calibration curves, analysis data, etc., obtained at the computer section 33. The automatic analyzing apparatus 100 includes an input interface 36 for enabling inputs for setting identification information, test item information, etc. for each sample, and so on. The automatic analyzing apparatus 100 also includes a system controller section 37 which takes total control over the analysis controller section 32, the computer section 33, the data storage 34, and the display 35.

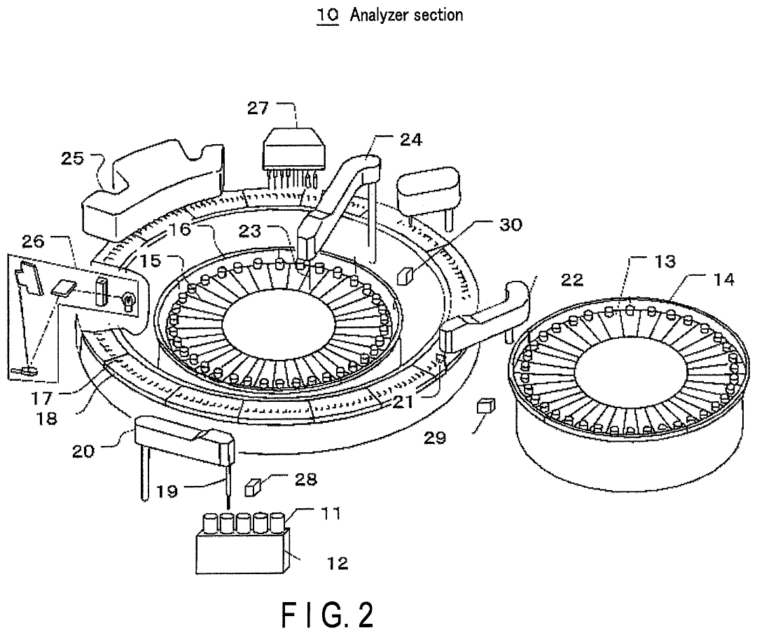

FIG. 2 is a perspective view showing an exemplary structure of the analyzer section 10. The analyzer section 10 is provided with one or more sample containers 11 each adapted to contain a sample such as a standard sample, a subject sample, or the like, and includes a sample rack 12 capable of holding more than one sample container 11. The analyzer section 10 is also provided with one or more first reagent containers 13 each adapted to contain a first reagent which is used as a reagent in, for example, a single-reagent system or a dual-reagent system to react with an ingredient in a sample for the intended test item. The analyzer section 10 includes a first reagent rack 14 for holding more than one first reagent container 13 in such a manner that the first reagent containers 13 can move. The analyzer section 10 is further provided with one or more second reagent containers 15 each adapted to contain a second reagent which forms a pair with the first reagent in the dual-reagent system. The analyzer section 10 includes a second reagent rack 16 for holding more than one second reagent container 15 in such a manner that the second reagent containers 15 can move.

The analyzer section 10 includes multiple reaction containers 17 circumferentially arranged at equal pitches, and a reaction disk 18 for holding the reaction containers 17 in such a manner that the reaction containers 17 can rotate. The analyzer section 10 includes a sample dispensing probe 19 for performing a dispensing action including aspiration of a sample from each sample container 11 and discharge of this sample into the intended reaction container 17. The analyzer section 10 includes a sample dispensing arm 20 for supporting the sample dispensing probe 19 in such a manner that the sample dispensing probe 19 can move vertically and also rotate.

The analyzer section 10 includes a first reagent dispensing probe 21 for performing a dispensing action including aspiration of the first reagent from each first reagent container 13 and discharge of this first reagent into the intended reaction container 17. The analyzer section 10 includes a first reagent dispensing arm 22 for supporting the first reagent dispensing probe 21 in such a manner that the first reagent dispensing probe 21 can move vertically and also rotate. The analyzer section 10 also includes a second reagent dispensing probe 23 for performing a dispensing action including aspiration of the second reagent from each second reagent container 15 and discharge of this second reagent into the intended reaction container 17. The analyzer section 10 includes a second reagent dispensing arm 24 for supporting the second reagent dispensing probe 23 in such a manner that the second reagent dispensing probe 23 can move vertically and also rotate.

The analyzer section 10 includes a stirrer 25 for stirring a reaction liquid in each reaction container 17, which may be a mixture of the sample and the first reagent or a mixture of the sample, the first reagent, and the second reagent. The analyzer section 10 includes a measurer 26 for optically measuring each stirred reaction liquid. The analyzer section 10 includes a washer 27 for washing the reaction containers 17 using one or more types of washing liquids. The analyzer section 10 also includes a washer 28 for washing the sample dispensing probe 19 using one or more types of washing liquids. The analyzer section 10 further includes a washer 29 for washing the first reagent dispensing probe 21 using one or more types of washing liquids, and a washer 30 for washing the second reagent dispensing probe 23 using one or more types of washing liquids.

The measurer 26, by measuring a reaction liquid containing a standard sample and a reagent or reagents, generates standard data which may be expressed as, for example, an absorbency level. The measurer 26 also generates subject data which may be expressed as an absorbency level, by measuring a reaction liquid containing a subject sample and a reagent or reagents.

Turning back to FIG. 1, the driver section 31 includes a conveyor mechanism and a mechanism for driving the conveyor mechanism to convey the sample rack 12 at the analyzer section 10. The driver section 31 also includes one or more mechanisms for driving each of the first reagent rack 14 and the second reagent rack 16 so that the first reagent containers 13 and the second reagent containers 15 each rotate. The driver section 31 includes a mechanism for driving the reaction disk 18 so that the reaction containers 17 each rotate.

The driver section 31 includes a mechanism for driving the sample dispensing arm 20 so as to rotate the sample dispensing probe 19 between a given position above one or more sample containers 11 and a given position above one or more reaction containers 17, and to vertically move the sample dispensing probe 19 between the given position above the one or more sample containers 11 and the target sample container 11 and between the given position above the one or more reaction containers 17 and the target reaction container 17.

The driver section 31 also includes a mechanism for driving the first reagent dispensing arm 22 to rotate the first reagent dispensing probe 21 between a given position above one or more first reagent containers 13 and a given position above one or more reaction containers 17, and to vertically move the first reagent dispensing probe 21 between the given position above the one or more first reagent containers 13 and the target first reagent container 13. The driver section 31 includes a mechanism for driving the second reagent dispensing arm 24 to rotate the second reagent dispensing probe 23 between a given position above one or more second reagent containers 15 and a given position above one or more reaction containers 17, and to vertically move the second reagent dispensing probe 23 between the given position above the one or more second reagent containers 15 and the target second reagent container 15.

The driver section 31 includes one or more mechanisms for driving the washers 27 to 30 for conducting the feeding and draining of their washing liquids.

The analysis controller section 32 includes a CPU and memory circuitry, and controls the driver section 31 to operate each component in the analyzer section 10 based on inputs given via the input interface 36. The analysis controller section 32, in response to an input given via the input interface 36 for starting a calibration for a test item, causes the components of the analyzer section 10 and the driver section 31 to carry out the calibration by conveying the sample rack 12, moving the first reagent container 13, the second reagent container 15, and the reaction container 17, dispensing the standard sample for the corresponding test item, dispensing the first reagent and/or the second reagent for the test item, stirring the reaction liquid, measuring the reaction liquid, washing the reaction container 17, the sample dispensing probe 19, and the first reagent dispensing probe 21 and/or the second reagent dispensing probe 23, and so on.

Also, the analysis controller section 32, in response to an input given via the input interface 36 for starting a test on a subject sample, causes the components of the analyzer section 10 and the driver section 31 to carry out the test by conveying the sample rack 12, moving the first reagent container 13, the second reagent container 15, and the reaction container 17, dispensing the subject sample, dispensing the first reagent and/or the second reagent for the test item, stirring the reaction liquid, measuring the reaction liquid, washing the reaction container 17, the sample dispensing probe 19, and the first reagent dispensing probe 21 and/or the second reagent dispensing probe 23, and so on.

The computer section 33 includes a CPU and memory circuitry, and generates a calibration curve for each test item based on standard data and a standard value or values. Here, the standard data has been generated by the measurer 26 of the analyzer section 10 through the calibration for the corresponding test item. The standard value indicates a concentration of the ingredient for this test item, set for the standard sample. The computer section 33 also generates, using the calibration curve for each test item, analysis data expressed as an activity value, a concentration, or other properties from subject data for the test item, generated by the measurer 26 through measurement of the subject sample.

The data storage 34 includes a storage which may be, for example, a hard disk drive (HDD), etc. The data storage 34 stores various data including identification information and standard values set for the standard samples for the respective test items, data generated by the analyzer section 10 such as the standard data and the subject data for the test items, data prepared and generated by the computer section 33 such as the calibration curves and the analysis data, and so on.

The display 35 includes one or more monitors constituted by, for example, a liquid crystal panel. The display 35 displays various setting screens such as a standard sample setting screen for setting identification information, standard values, etc. for standard samples for the respective test items, a subject sample setting screen for setting identification information, test items, etc. for subject samples, and so on. The display 35 also displays various data including the standard data and the subject data generated by the analyzer section 10, the calibration curves and the analysis data generated by the computer section 33, and so on.

The input interface 36 includes, for example, one or more input devices such as a keyboard, a mouse, buttons, and a touch key panel. The input interface 36 enables inputs to set identification information, standard values, etc. for standard samples for the respective test items. The input interface 36 also enables inputs to start calibrations for the respective test items. The input interface 36 enables inputs to set identification information and test item information for the subject samples. The input interface 36 also enables inputs to start tests on subject samples.

The system controller section 37 includes a CPU and memory circuitry, and stores command signals, input information, etc., input via the input interface 36 in the memory circuitry. Based on the input information, the system controller section 37 controls the entire system by performing a total control over the analysis controller section 32, the computer section 33, the data storage 34, and the display 35.

A description will be given of an exemplary configuration of the washers 27 to 30 in the analyzer section 10, and an exemplary washing operation performed with them.

First, FIGS. 1 to 3 will be referred to for describing an exemplary configuration of the washer 27. In one example, this washer 27 uses first to third washing liquids to wash the reaction containers 17. The first washing liquid may be, for example, pure water. The second washing liquid is constituted by a first liquid and a second liquid. The first liquid may be the first washing liquid and serves as a diluent. The second liquid is, for example, a concentrated alkaline liquid containing a high concentration of a detergent component, which provides a higher detergency than the first washing liquid. In the second washing liquid, the second liquid is diluted with the first liquid. The third washing liquid is constituted by the first liquid and a third liquid. The third liquid is, for example, a concentrated acidic liquid containing a high concentration of a detergent component, which provides a higher detergency than the first washing liquid. In the third washing liquid, the third liquid is diluted with the first liquid.

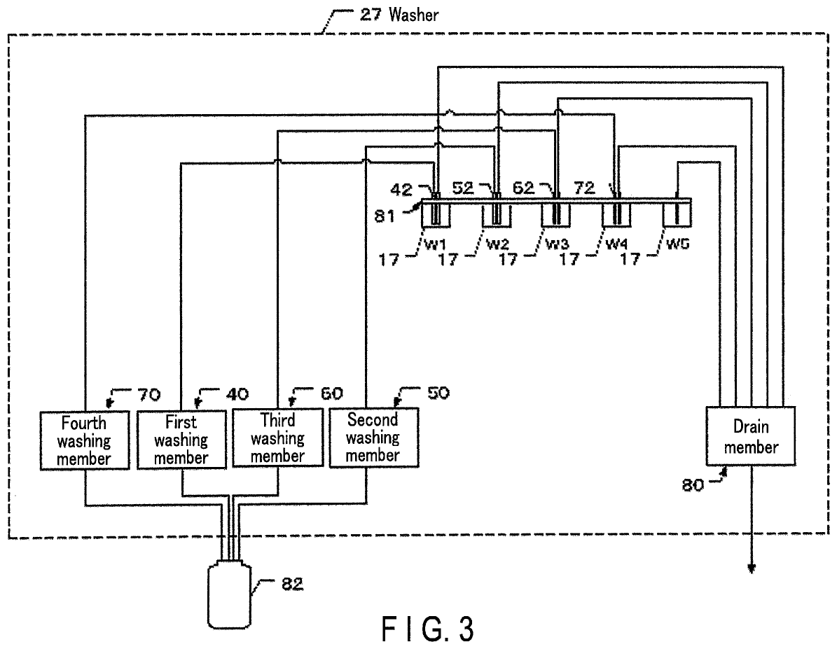

FIG. 3 shows a configuration of the washer 27. The washer 27 includes first to fourth washing members 40, 50, 60, and 70 for washing the respective reaction containers 17 stopped at first to fourth washing positions W1 to W4 for every one cycle time, using the first liquid retained in a first reservoir 82.

The first washing member 40 discharges the first washing liquid into the reaction container 17 stopped at the first washing position W1. The second washing member 50 discharges the second washing liquid into the reaction container 17 stopped at the second washing position W2. The third washing member 60 discharges the third washing liquid into the reaction container 17 stopped at the third washing position W3. The fourth washing member 70 discharges the first washing liquid into the reaction container 17 stopped at the fourth washing position W4.

The washer 27 also includes a drain member 80 for draining liquids in the reaction containers 17, including: the reaction liquid present within the reaction container 17 stopped at the first washing position W1; the first washing liquid discharged at the first washing position W1 and then present within the reaction container 17 stopped at the second washing position W2; the second washing liquid discharged at the second washing position W2 and then present within the reaction container 17 stopped at the third washing position W3; the third washing liquid discharged at the third washing position W3 and then present within the reaction container 17 stopped at the fourth washing position W4; and the first washing liquid discharged at the fourth washing position W4 and then present within the reaction container 17 stopped at a fifth washing position W5.

The washer 27 includes one or more holders 81 adapted to hold given components of the first to fourth washing members 40, 50, 60, and 70 and the drain member 80 in such a manner that these components can be moved up and down.

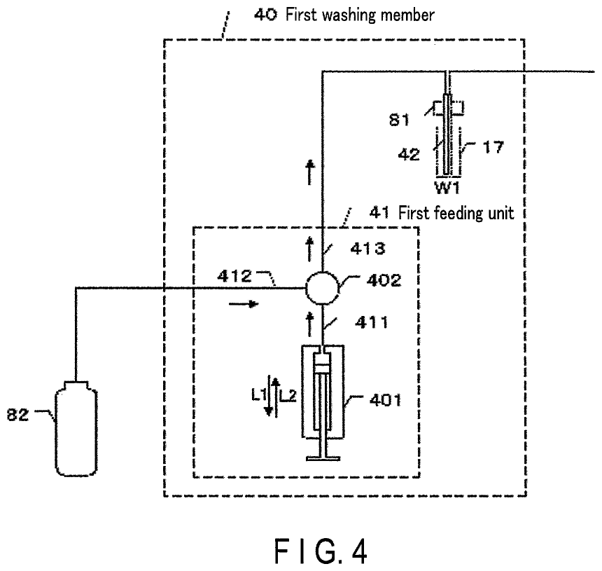

Next, FIG. 4 will be referred to for describing a configuration of the first washing member 40.

FIG. 4 shows an exemplary configuration of the first washing member 40. The first washing member 40 includes a first feeding unit 41 for feeding the first washing liquid, and a first discharge nozzle 42 for discharging the first washing liquid fed from the first feeding unit 41.

The first feeding unit 41 includes a first feeding pump 401 and a first valve 402 with first to third ports. The first feeding unit 41 includes a tube 411 forming a first-liquid channel between the first feeding pump 401 and the first port of the first valve 402, a tube 412 forming another first-liquid channel between the second port of the first valve 402 and the first reservoir 82, and a tube 413 forming a further first-liquid channel between the third port of the first valve 402 and the first discharge nozzle 42.

The first feeding pump 401 is constituted by, for example, a syringe, a plunger, etc. The first feeding pump 401 is driven by the driver section 31 to perform a sucking action where the plunger slides in the direction of arrow L1 and an ejecting action where the plunger slides in the direction of arrow L2.

The first valve 402 is, for example, a three-way solenoid valve, which may be driven by the driver section 31 to open the flow path between the first port and the second port while closing the flow path between the first port and the third port. Also, the first valve 402 may be adapted to open the flow path between the first port and the third port while closing the flow path between the first port and the second port, during the suspension of driving.

The first discharge nozzle 42 has a discharge hole at its lower end. The first discharge nozzle 42 is provided so that it can enter the reaction container 17 arranged at the first washing position W1 upon the holder 81 making a vertical movement according to the driving of the driver section 31. While the reaction containers 17 are rotating, the first discharge nozzle 42 is kept stationary at an upper stop position above the rotation trajectory of the reaction containers 17. While the rotation of the reaction containers 17 is halted, the first discharge nozzle 42 descends and reaches a lower stop position where its lower end comes close to the bottom of the reaction container 17 placed at the first washing position W1.

Next, FIGS. 3 and 4 will be referred to for describing a washing operation conducted with the first washing member 40.

Here, the first feeding pump 401, the first valve 402, the tubes 411 to 413, and the first discharge nozzle 42 are all filled with the first liquid. Under the condition that the first valve 402 opens the flow path between the first port and the second port while closing the flow path between the first port and the third port, the first feeding pump 401 performs a sucking action to draw the first liquid from the first reservoir 82. In response to the first feeding pump 401 finishing the sucking action, the first valve 402 closes the flow path between the first port and the second port and opens the flow path between the first port and the third port.

In response to the measurer 26 finishing the measurement and the reaction container 17 being stopped at the first washing position W1, the first discharge nozzle 42 descends and stays at the lower stop position. After the reaction liquid is removed from the reaction container 17 by a draining action of the drain member 80, the first feeding pump 401 performs an ejecting action to feed, as the first washing liquid, the first liquid to the first discharge nozzle 42 in an amount greater than the amount of the reaction liquid that has been present in the reaction container 17 and removed therefrom. The first discharge nozzle 42 discharges the first washing liquid to the inside of the reaction container 17 according to the ejecting action of the first feeding pump 401.

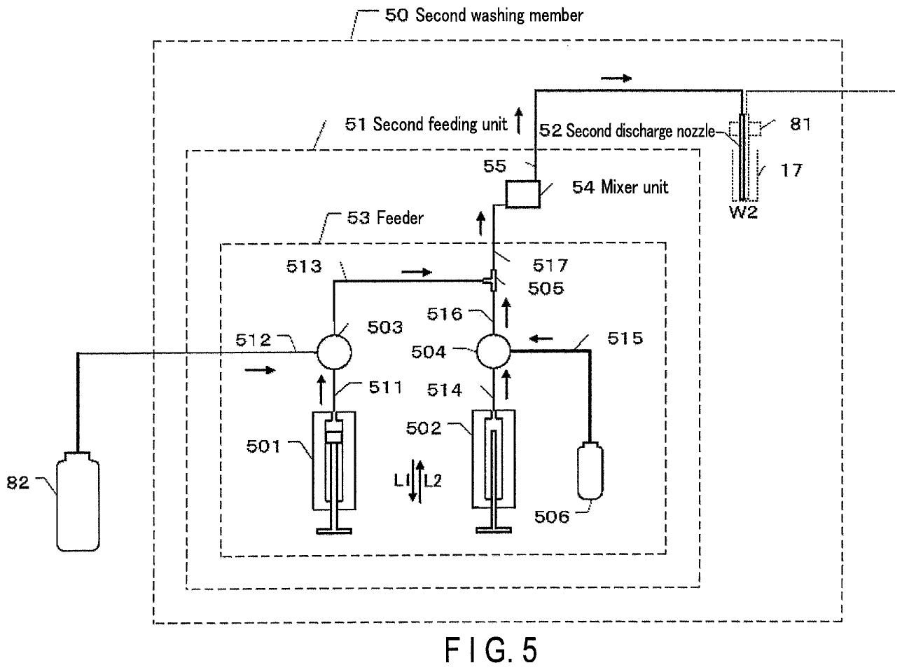

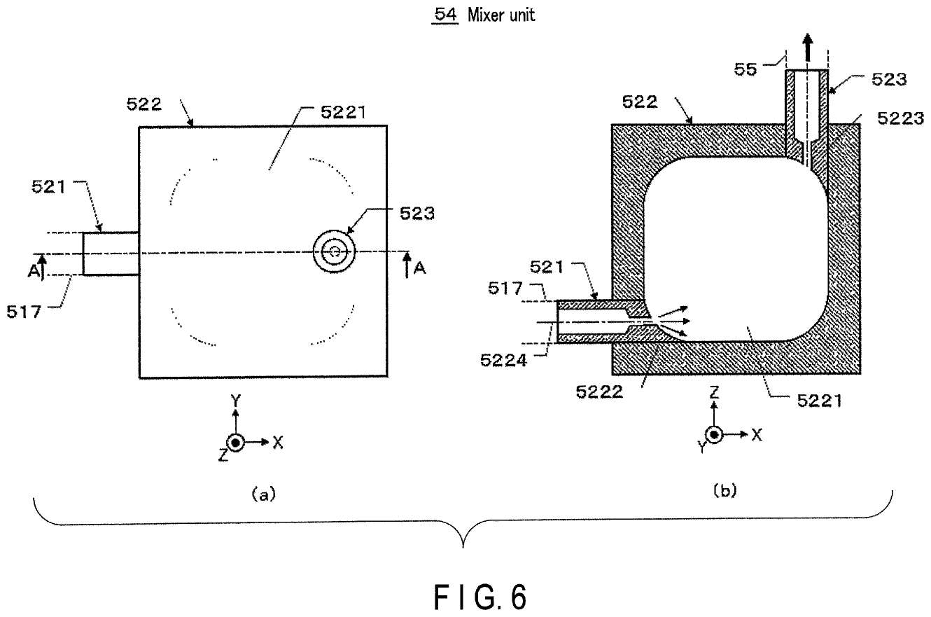

Next, FIGS. 5 to 6 will be referred to for describing a configuration of the second washing member 50.

FIG. 5 shows an exemplary configuration of the second washing member 50. The second washing member 50 includes a second feeding unit 51 for feeding the second washing liquid, and a second discharge nozzle 52 for discharging the second washing liquid fed from the second feeding unit 51.

The second feeding unit 51 is constituted by a feeder 53 for feeding the first liquid and the second liquid, and a mixer unit 54 for mixing the first liquid and the second liquid fed from the feeder 53 to prepare a mixture, namely, the second washing liquid. The second feeding unit 51 also includes a tube 55 having one end connected to the mixer unit 54 and the other end connected to the second discharge nozzle 52.

The feeder 53 includes first and second feeding pumps 501 and 502, and first and second valves 503 and 504 each with first to third ports. The feeder 53 includes a three-way branch pipe 505 with first to third ports, and a second reservoir 506 which retains the second liquid. The feeder 53 includes a tube 511 forming a first-liquid channel between the first feeding pump 501 and the first port of the first valve 503, and a tube 512 forming another first-liquid channel between the second port of the first valve 503 and the first reservoir 82.

Also, the feeder 53 includes a tube 513 forming a further first-liquid channel between the third port of the first valve 503 and the first port of the three-way branch pipe 505, and a tube 514 forming a second-liquid channel between the second feeding pump 502 and the first port of the second valve 504. The feeder 53 includes a tube 515 forming another second-liquid channel between the second port of the second valve 504 and the second reservoir 506, and a tube 516 forming a further second-liquid channel between the third port of the second valve 504 and the second port of the three-way branch pipe 505. The feeder 53 further includes a tube 517 forming a multi-liquid channel between the third port of the three-way branch pipe 505 and the mixer unit 54 and having a constant diameter throughout from one end to the other end.

The first and second feeding pumps 501 and 502 are each constituted by, for example, a syringe, a plunger, etc. The first feeding pump 501 is driven by the driver section 31 to perform a sucking action where the plunger slides in the direction of arrow L1 for sucking the first liquid from the first reservoir 82, and to perform an ejecting action where the plunger slides in the direction of arrow L2 for ejecting the first liquid in a first amount. The second feeding pump 502 is driven by the driver section 31 to perform a sucking action where the plunger slides in the L1 direction for sucking the second liquid from the second reservoir 506, and to perform an ejecting action where the plunger slides in the L2 direction for ejecting the second liquid in a second amount smaller than the first amount.

Each of the first and second valves 503 and 504 is, for example, a three-way solenoid valve which may be driven by the driver section 31 to open the flow path between the first port and the second port while closing the flow path between the first port and the third port. The first and second valves 503 and 504 may each be adapted to open the flow path between the first port and the third port while closing the flow path between the first port and the second port, during the suspension of driving by the driver section 31.

The feeder 53 intermittently feeds the first liquid and the second liquid to the mixer unit 54 for every one cycle time. The feeder 53, in response to the reaction container 17 stopped at the second washing position W2, performs the sucking action and the ejecting action with each of the first and second feeding pumps 501 and 02 so that the first liquid and the second liquid are fed to the mixer unit 54 one time.

FIG. 6 is a diagram showing an exemplary structure of the mixer unit 54. Here, FIG. 6(a) is a planar view of the mixer unit 54, and FIG. 6(b) is a cross-section along the line A-A viewed in the arrow direction. The description of the mixer unit 54 will assume that an X axis extends in a horizontal direction, a Y axis extends in another horizontal direction orthogonal to the X axis, and a Z axis extends in a direction orthogonal to both the X axis and the Y axis. However, the mixer unit 54 may be arranged in any orientation, etc.

The mixer unit 54 includes an inflow part 521, a main part 522, and an outflow part 523. The first liquid and the second liquid fed from the feeder 53 enter through the inflow part 521. The main part 522 has a shape of, for example, a rectangular parallelepiped or a cuboid and includes an internal space 5221 in which the first liquid and the second liquid that have entered through the inflow part 521 flow. The first liquid and the second liquid that have flown inside the internal space 5221 of the main part 522 exit through the outflow part 523.

The inflow part 521 is provided at or near the lower central portion of one side surface of the main part 522, and has one end connected to the tube 517 of the feeder 53 and the other end joined to the main part 522. The inflow part 521 includes a channel that has been formed so that a cross-sectional area on the side of said other end has a size smaller than a cross-sectional area on the side of said one end, with a line 5224 extending through them as a central axis parallel to the X axis. Here, the channel of the inflow part 521 is designed so that its cross-sectional area on the side of said other end is smaller than the cross-sectional area of the tube 517 serving as a multi-liquid channel.

The main part 522 includes the internal space 5221, and also an inlet 5222 and an outlet 5223. The internal space 5221 is formed so that its cross-sectional area normal to the line 5224 is larger than the cross-sectional area of the tube 517 serving as a multi-liquid channel. The internal space 5221 defines a shape of, for example, a die or a cuboid having portions where its surfaces cross at right angles rounded. The internal space 5221 is tightly sealed except at the inlet 5222 and the outlet 5223. Assuming that the sum of an amount of the first liquid, i.e., the first amount, and an amount of the second liquid, i.e., the second amount, ejected from the respective first and second feeding pumps 501 and 502 is a third amount, the internal space 5221 has a volumetric capacity capable of containing more than the third amount, for example, an amount equal to or greater than double the third amount.

The inlet 5222 is formed at the side surface of the main part 522 and penetrates through the main part 522 between the outside and the inside. The inlet 5222 is plugged by the inflow part 521. The outlet 5223 is formed at a position of the top surface of the main part 522, which is a position distant from the inlet 5222 among positions of the top surface, and penetrates through the main part 522 between the outside and the inside. The outlet 5223 is plugged by the outflow part 523.

The outflow part 523 is provided at a position of the top surface of the main part 522, which is a position distant in the X-axis direction from the inflow part 521 and located at the center in the Y-axis direction among positions of the top surface. The outflow part 523 includes a channel having a central axis parallel to the Z axis. Here, the outflow part 523 is arranged so that the extension of this central axis orthogonally crosses the extension of the line 5224. The outflow part 523 has one end connected to the tube 55 and the other end joined to the main part 522. The channel of the outflow part 523 has been formed so that a cross-sectional area on the side of said other end has a size smaller than a cross-sectional area on the side of said one end.

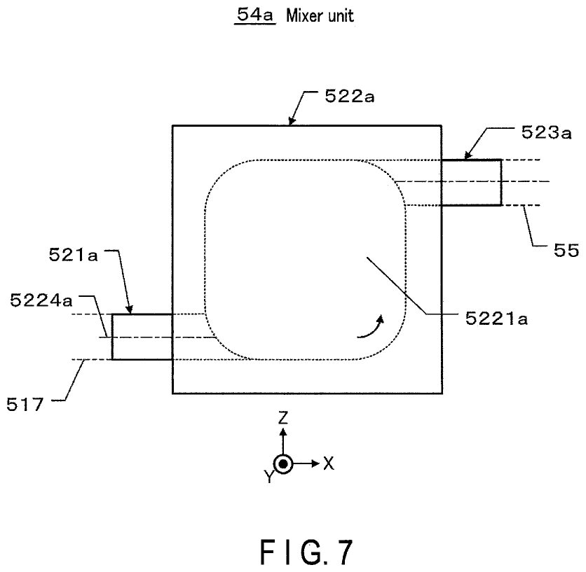

Note that the embodiment is not limited to the mixer unit 54. For example, a mixer unit 54a as shown in FIG. 7 may be employed.

FIG. 7 is a diagram showing a structure of the mixer unit 54a. The description of the mixer unit 54a will assume that an X axis extends in a horizontal direction, a Y axis extends in another horizontal direction orthogonal to the X axis, and a Z axis extends in a direction orthogonal to both the X axis and the Y axis. However, the mixer unit 54a may be arranged in any orientation, etc.

The mixer unit 54a differs from the mixer unit 54 shown in FIG. 6 in the locations of the inflow part and the outflow part with respect to the main part.

The mixer unit 54a includes an inflow part 521a, a main part 522a, and an outflow part 523a. The first liquid and the second liquid enter through the inflow part 521a. The main part 522a has a shape of a rectangular parallelepiped or a cuboid and includes an internal space 5221a in which the first liquid and the second liquid that have entered through the inflow part 521a flow. The first liquid and the second liquid that have flown inside the internal space 5221a of the main part 522a exit through the outflow part 523a.

The inflow part 521a is provided at or near the lower central portion of one side surface of the main part 522a, and has one end connected to the tube 517 and the other end joined to the main part 522a. The inflow part 521a includes a channel that has been formed so that a cross-sectional area on the side of said other end has a size smaller than a cross-sectional area on the side of said one end, with a line 5224a extending through them as a central axis parallel to the X axis. The channel of the inflow part 521a is designed so that its cross-sectional area on the side of said other end is smaller than the cross-sectional area of the tube 517 serving as a multi-liquid channel.

The main part 522a includes the internal space 5221a, and also a non-illustrated inlet plugged by the inflow part 521a and a non-illustrated outlet plugged by the outflow part 523a. The internal space 5221a has the same shape and the same volumetric capacity as those of the internal space 5221 shown in FIG. 6, and its cross-sectional area normal to the line 5224a parallel to the X axis is larger than the cross-sectional area of the tube 517 serving as the multi-liquid channel.

The outflow part 523a is provided at or near the upper central portion of one side surface of the main part 522a which is opposite to the side surface where the inflow part 521a is provided. The outflow part 523a has one end connected to the tube 55 and the other end joined to the main part 522a. The outflow part 523a includes a channel formed so that a cross-sectional area on the side of said other end has a size smaller than a cross-sectional area on the side of said one end, with a central axis parallel to the line 5224a extending through them.

Note that it is also possible to arrange the inflow part 521a at the center of one side surface of the main part 522a while arranging the outflow part 523a at the center of the opposing side surface of the main part 522a. Further, it is likewise possible to arrange the inflow part 521a at a position of one side surface of the main part 522a, which is a position in the lower part of the side surface and close to one edge in the Y-axis direction, while arranging the outflow part 523a at a position of the opposing side surface of the main part 522a, which is a position in the upper part of this opposing side surface and close to the opposing edge in the Y-axis direction.

Next, FIGS. 3, 5, and 6 will be referred to for describing a washing operation conducted with the second washing member 50.

Components in the feeder 53, namely, the first feeding pump 501, the first valve 503, the first port of the three-way branch pipe 505, and the tubes 511 to 513 serving as the first-liquid channels are all filled with the first liquid attributable to sucking and ejecting actions of the first feeding pump 501. Also, the second feeding pump 502, the second valve 504, the second port of the three-way branch pipe 505, and the tubes 514 to 516 serving as the second-liquid channels are all filled with the second liquid attributable to sucking and ejecting actions of the second feeding pump 502. The first and second valves 503 and 504 are each in the state where the flow path between the first port and the third port is open and the flow path between the first port and the second port is closed. Also, the tube 517 serving as a multi-liquid channel, the mixer unit 54, the tube 55, and the second discharge nozzle 52 are all filled with a mixture of the first liquid and the second liquid attributable to sucking and ejecting actions of the first and second feeding pumps 501 and 502.

Under the condition that the first and second valves 503 and 504 each close the flow path between the first port and the third port and open the flow path between the first port and the second port, the first feeding pump 501 performs a sucking action to draw the first amount of the first liquid from the first reservoir 82 and the second feeding pump 502 performs a sucking action to draw the second amount of the second liquid from the second reservoir 506. In response to the first and second feeding pumps 501 and 502 finishing their respective sucking actions, the first and second valves 503 and 504 each close the flow path between the first port and the second port and open the flow path between the first port and the third port.

In response to the reaction container 17 that has been subjected to the discharge of the first washing liquid being stopped at the second washing position W2 next to the first washing position W1 upon elapse of n cycle times (where n is a positive integer) since this reaction container 17 made a stop at the first washing position W1, the second discharge nozzle 52 descends and stays at the lower stop position. After the first washing liquid is removed from the reaction container 17 by a draining action of the drain member 80, the first and second feeding pumps 501 and 502 substantially simultaneously perform their ejecting actions to feed the first liquid and the second liquid, which together amount to the third amount.

Note that the second feeding pump 502 here is intended to eject an amount smaller than the amount ejected by the first feeding pump 501. Thus, a configuration of driving the second feeding pump 502 to perform its ejecting action while the first feeding pump 501 is performing the ejecting action may be adopted.

The ejecting action of the first feeding pump 501 causes the first liquid in the tubes 511 and 513 to flow toward the three-way branch pipe 505 as shown by the corresponding arrows. Also, the ejecting action of the second feeding pump 502 causes the second liquid in the tubes 514 and 516 to flow toward the three-way branch pipe 505 as shown by the corresponding arrows. Then, attributable to the ejecting actions of the first and second feeding pumps 501 and 502, the first liquid flown through the first port of the three-way branch pipe 505 and the second liquid flown through the second port of the three-way branch pipe 505 are joined together at the third port of the three-way branch pipe 505 and caused to flow in the tube 517 toward the mixer unit 54 as shown by the corresponding arrow.

In this manner, the first liquid and the second liquid are caused to join together in the three-way branch pipe 505 and then flow within the tube 517, so that the first liquid and the second liquid can be mingled together in the tube 517.

The first liquid and the second liquid enter the inflow part 521 of the mixer unit 54 according to the ejecting actions of the first and second feeding pumps 501 and 502, and further flow into the internal space 5221 in a radial fashion around the line 5224 from the opening at the other end of the channel in the inflow part 521 and at a higher velocity than the velocity of the flow within the tube 517. See the arrows shown in FIG. 6(b). The first liquid and the second liquid already present in the internal space 5221 are mixed by the first liquid and the second liquid entering from the inflow part 521, and the former first and second liquids and the latter first and second liquids are together caused to flow toward the outflow part 523 as an integral current.

According to the inflow of the first liquid and the second liquid into the internal space 5221, the third amount of a mixture of the first liquid and the second liquid among the first liquid and the second liquid within the internal space 5221 is caused to flow out from the outflow part 523, and then flow in the tube 55 toward the second discharge nozzle 52 as the second washing liquid. The second discharge nozzle 52 discharges the third amount of the second washing liquid to the inside of the reaction container 17 according to the ejecting actions of the first and second feeding pumps 501 and 502.

As described above, a mixture of the first liquid and the second liquid is caused to flow into the internal space 5221 from the opening at the other end of the channel in the inflow part 521. Here, the cross-sectional area of the internal space 5221, which is normal to the central axis of the channel in the inflow part 521, is larger than the cross-sectional area of the tube 517 serving as a multi-liquid channel. Also, the other end of the channel in the inflow part 521 (i.e., the opening at the other end) has a cross-sectional area smaller than the cross-sectional area of the tube 517 serving as a multi-liquid channel. Accordingly, the mixture of the first liquid and the second liquid flows through the channel in the inflow part 521 at a higher velocity than the velocity of the flow within the tube 517 and enters the internal space 5221 in a radial fashion.

The first liquid and the second liquid already present in the internal space 5221 are mixed by the first liquid and the second liquid introduced from the inflow part 521. The first liquid and the second liquid already present in the internal space 5221 are thus caused to flow together with the introduced first and second liquids as an integral current, within the internal space 5221 and toward the outflow part 523. Therefore, the first liquid and the second liquid are more strongly mixed with each other than in the case of being mixed only within the tube 517. This allows for the preparation of the second washing liquid with a constant concentration of the detergent component provided from the second liquid.

This second washing liquid prepared through the step of strongly mixing the first liquid and the second liquid with the mixer unit 54 is discharged from the second discharge nozzle 52. Therefore, it is possible to avoid the degradation of analysis data that could result from a poor capability to wash the reaction container 17 due to the washing liquid having a reduced detergent component concentration, or the degradation of analysis data that could result from the detergent component remaining in the reaction container 17 due to the washing liquid having an increased detergent component concentration.

Additionally, in the configuration where the mixer unit 54a shown in FIG. 7 is adopted, the first liquid and the second liquid flow through the channel in the inflow part 521a at a higher velocity than the velocity of the flow within the tube 517 and enter the internal space 5221a along the line 5224a. This causes the first liquid and the second liquid already present in the internal space 5221a to be mixed by the first liquid and the second liquid introduced along the line 5224a from the inflow part 521a, in such a manner that they swirl in the arrow direction shown in FIG. 7 at the curved face in the internal space 5221a where the extension of the line 5224a crosses, so that the former first and second liquids and the latter first and second liquids are caused to flow together as an integral current within the internal space 5221a and exit from the outflow part 523a. Therefore, the first liquid and the second liquid are more strongly mixed with each other than in the case of being mixed only within the tube 517. This allows for the preparation of the second washing liquid with a constant concentration of the detergent component provided from the second liquid.

Next, FIGS. 5, 6, and 8 will be referred to for describing a configuration of the third washing member 60.

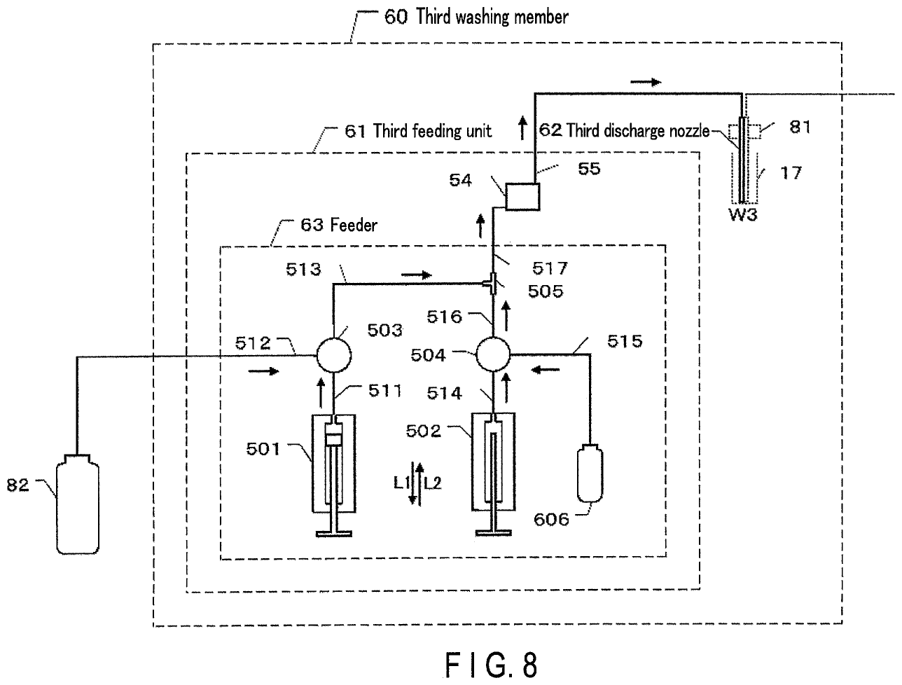

FIG. 8 shows an exemplary configuration of the third washing member 60. Note that, for the components of the third washing member 60 which are substantially the same as the components of the second washing member 50 shown in FIG. 5, the description will use the same reference numbers or symbols as those of the second washing member 50 and omit their explanations.

The third washing member 60 includes a third feeding unit 61 for feeding the third washing liquid, and a third discharge nozzle 62 for discharging the third washing liquid fed from the third feeding unit 61.

The third feeding unit 61 is constituted by a feeder 63 for feeding the first liquid and the third liquid, and a mixer unit 54 for mixing the first liquid and the third liquid fed from the feeder 63 to prepare a mixture, namely, the third washing liquid. The third feeding unit 61 also includes a tube 55 having one end connected to the mixer unit 54 and the other end connected to the third discharge nozzle 62.

The feeder 63 differs from the feeder 53 shown in FIG. 5 in that the second reservoir 506 is replaced with a third reservoir 606 retaining the third liquid. The tube 515 here has its one end connected to the second port of the second valve 504 and the other end connected to the third reservoir 606.

The third discharge nozzle 62 has a discharge hole at its lower end, and is held by the holder 81. The third discharge nozzle 62 is provided so that it can enter the reaction container 17 arranged at the third washing position W3 upon the holder 81 making a vertical movement according to the driving of the driver section 31. While the reaction containers 17 are rotating, the third discharge nozzle 62 is kept stationary at an upper stop position above the rotation trajectory of the reaction containers 17. While the rotation of the reaction containers 17 is halted, the third discharge nozzle 62 descends and reaches a lower stop position where its lower end comes close to the bottom of the reaction container 17 placed at the third washing position W3 next to the second washing position W2.

FIGS. 3, 6, and 8 will be referred to for describing a washing operation conducted with the third washing member 60.

Components in the feeder 63 of the third feeding unit 61, namely, the first feeding pump 501, the first valve 503, the first port of the three-way branch pipe 505, and the tubes 511 to 513 are all filled with the first liquid. Also, the second feeding pump 502, the second valve 504, the second port of the three-way branch pipe 505, and the tubes 514 to 516 are all filled with the third liquid. The tube 517, the mixer unit 54, the tube 55, and the third discharge nozzle 62 are all filled with a mixture of the first liquid and the third liquid. The first and second valves 503 and 504 are each in the state where the flow path between the first port and the third port is open and the flow path between the first port and the second port is closed. The tube 517, the mixer unit 54, the tube 55, and the third discharge nozzle 62 are filled with a mixture of the first liquid and the third liquid.

Under the condition that the first and second valves 503 and 504 each close the flow path between the first port and the third port and open the flow path between the first port and the second port, the first feeding pump 501 performs a sucking action to draw the first amount of the first liquid from the first reservoir 82 and the second feeding pump 502 performs a sucking action to draw the second amount of the third liquid from the third reservoir 606. In response to the first and second feeding pumps 501 and 502 finishing their respective sucking actions, the first and second valves 503 and 504 each close the flow path between the first port and the second port and open the flow path between the first port and the third port.

In response to the reaction container 17 that has been subjected to the discharge of the second washing liquid being stopped at the third washing position W3 next to the second washing position W2 upon elapse of n cycle times since this reaction container 17 made a stop at the second washing position W2, the third discharge nozzle 62 descends and stays at the lower stop position. After the second washing liquid is removed from the reaction container 17 by a draining action of the drain member 80, the first and second feeding pumps 501 and 502 substantially simultaneously perform their ejecting actions to feed the first liquid and the third liquid, which together amount to the third amount.

The ejecting action of the first feeding pump 501 causes the first liquid in the tubes 511 and 513 to flow toward the three-way branch pipe 505, and the ejecting action of the second feeding pump 502 causes the third liquid in the tubes 514 and 516 to flow toward the three-way branch pipe 505. Then, attributable to the ejecting actions of the first and second feeding pumps 501 and 502, the first liquid flown through the first port of the three-way branch pipe 505 and the third liquid flown through the second port of the three-way branch pipe 505 are joined together at the third port of the three-way branch pipe 505 and caused to flow in the tube 517 toward the mixer unit 54.

In this manner, the first liquid and the third liquid are caused to join together in the three-way branch pipe 505 and then flow within the tube 517, so that the first liquid and the third liquid can be mingled together in the tube 517.

The first liquid and the third liquid enter the inflow part 521 of the mixer unit 54 according to the ejecting actions of the first and second feeding pumps 501 and 502, and further flow into the internal space 5221 in a radial fashion around the line 5224 from the opening at the other end of the channel in the inflow part 521 and at a higher velocity than the velocity of the flow within the tube 517. The first liquid and the third liquid introduced into the internal space 5221 flow toward the outflow part

According to the inflow of the first liquid and the third liquid into the internal space 5221, the third amount of a mixture of the first liquid and the third liquid among the first liquid and the third liquid that fill the internal space 5221 is caused to flow out from the outflow part 523, and then flow in the tube 55 toward the third discharge nozzle 62 as the third washing liquid. The third discharge nozzle 62 discharges the third amount of the third washing liquid to the inside of the reaction container 17 according to the ejecting actions of the first and second feeding pumps 501 and 502.

As described above, a mixture of the first liquid and the third liquid is caused to flow into the internal space 5221 from the opening at the other end of the channel in the inflow part 521. Here, the cross-sectional area of the internal space 5221, which is normal to the central axis of the channel in the inflow part 521, is larger than the cross-sectional area of the tube 517 serving as a multi-liquid channel. Also, the other end of the channel in the inflow part 521 (i.e., the opening at the other end) has a cross-sectional area smaller than the cross-sectional area of the tube 517 serving as a multi-liquid channel. Accordingly, the mixture of the first liquid and the third liquid flows through the channel in the inflow part 521 at a higher velocity than the velocity of the flow within the tube 517 and enters the internal space 5221 in a radial fashion.

The first liquid and the third liquid already present in the internal space 5221 are mixed by the first liquid and the third liquid introduced from the inflow part 521. The first liquid and the third liquid already present in the internal space 5221 are thus caused to flow together with the introduced first and third liquids as an integral current, within the internal space 5221 and toward the outflow part 523. Therefore, the first liquid and the third liquid are more strongly mixed with each other than in the case of being mixed only within the tube 517. This allows for the preparation of the third washing liquid with a constant concentration of the detergent component provided from the third liquid.

The third washing liquid prepared through the step of strongly mixing the first liquid and the third liquid with the mixer unit 54 is discharged from the third discharge nozzle 62. Therefore, it is possible to avoid the degradation of analysis data that could result from a poor capability to wash the reaction container 17 due to the washing liquid having a reduced detergent component concentration, or the degradation of analysis data that could result from the detergent component remaining in the reaction container 17 due to the washing liquid having an increased detergent component concentration.

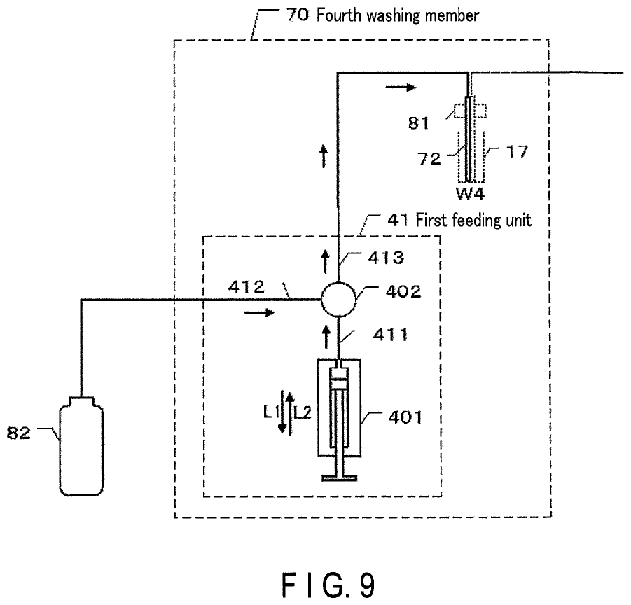

Next, FIGS. 4 and 9 will be referred to for describing a configuration of the fourth washing member 70.

FIG. 9 shows an exemplary configuration of the fourth washing member 70. The fourth washing member 70 differs from the first washing member 40 shown in FIG. 4 in that the first discharge nozzle 42 of the first washing member 40 is replaced with a fourth discharge nozzle 72. The fourth washing member 70 includes a first feeding unit 41, and this fourth discharge nozzle 72 for discharging the first washing liquid fed from the first feeding unit 41. The tube 413 of the first feeding unit 41 here has its one end connected to the third port of the first valve 402 and the other end connected to the fourth discharge nozzle 72.

The fourth discharge nozzle 72 has a discharge hole at its lower end. The fourth discharge nozzle 72 is provided so that it can enter the reaction container 17 arranged at the fourth washing position W4 upon the holder 81 making a vertical movement according to the driving of the driver section 31. The fourth discharge nozzle 72 is connected to the tube 413 of the first feeding unit 41. While the reaction containers 17 are rotating, the fourth discharge nozzle 72 is kept stationary at an upper stop position above the rotation trajectory of the reaction containers 17. While the rotation of the reaction containers 17 is halted, the fourth discharge nozzle 72 descends and reaches a lower stop position where its lower end comes close to the bottom of the reaction container 17 placed at the fourth washing position W4.

Next, FIGS. 3 and 9 will be referred to for describing a washing operation conducted with the fourth washing member 70. The fourth washing member 70 may perform the washing operation for the reaction container 17 placed at the fourth washing position W4, at the same timing as the first washing member 40 performing its washing operation.

The first feeding pump 401 of the first feeding unit 41, and also the first valve 402, the tubes 411 to 413, and the fourth discharge nozzle 72 are filled with the first liquid. Under the condition that the first valve 402 opens the flow path between the first port and the second port while closing the flow path between the first port and the third port, the first feeding pump 401 performs a sucking action to draw the first liquid from the first reservoir 82. In response to the first feeding pump 401 finishing the sucking action, the first valve 402 closes the flow path between the first port and the second port and opens the flow path between the first port and the third port.

In response to the reaction container 17 that has been subjected to the discharge of the third washing liquid being stopped at the fourth washing position W4 next to the third washing position W3 upon elapse of n cycle times since this reaction container 17 made a stop at the third washing position W3, the fourth discharge nozzle 72 descends and stays at the lower stop position. After the third washing liquid is removed from the reaction container 17 by a draining action of the drain member 80, the first feeding pump 401 performs an ejecting action to feed, as the first washing liquid, the first liquid to the fourth discharge nozzle 72. The fourth discharge nozzle 72 discharges the first washing liquid fed according to the ejecting action of the first feeding pump 401, to the inside of the reaction container 17.

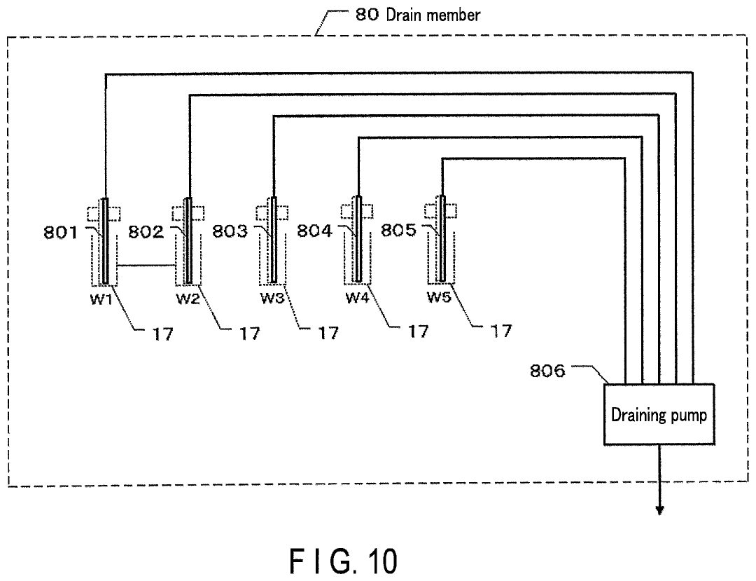

Next, FIGS. 3 and 10 will be referred to for describing a configuration of the drain member 80 and a washing operation conducted with the drain member 80.

FIG. 10 shows an exemplary configuration of the drain member 80. The drain member 80 includes first to fifth suction nozzles 801 to 805, and a draining pump 806 connected with each of the first to fifth suction nozzles 801 to 805 via respective tubes.

The first to fifth suction nozzles 801 to 805 each have a suction hole at the lower end, and are held by the holder 81. The first to fifth suction nozzles 801 to 805 are provided so that they can enter the respective reaction containers 17 arranged at the first to fifth washing positions W1 to W5 upon the holder 81 making a vertical movement according to the driving of the driver section 31.

While the reaction containers 17 are rotating, the first to fifth suction nozzles 801 to 805 are kept stationary at their respective upper stop positions above the rotation trajectory of the reaction containers 17. While the rotation of the reaction containers 17 is halted, the first to fifth suction nozzles 801 to 805 descend and reach their respective lower stop positions where the lower end comes close to the bottom of the corresponding one of the reaction containers 17 placed at the first to fifth washing positions W1 to W5. Here, with the action of the draining pump 806, the first to fourth suction nozzles 801 to 804 suck and drain the reaction liquid in the reaction container 17 at the first washing position W1, the first washing liquid in the reaction container 17 at the second washing position W2, the second washing liquid in the reaction container 17 at the third washing position W3, and the third washing liquid in the reaction container 17 at the fourth washing position W4.

Also, the fifth suction nozzle 805 sucks and drains the first washing liquid in the reaction container 17 stopped at the fifth washing position W5 next to the fourth washing position W4 upon elapse of n cycle times since this reaction container 17 made a stop at the fourth washing position W4.

FIGS. 4, 5, 6, and 11 will be referred to for describing a configuration of the washer 28 and a washing operation conducted with the washer 28. As the washers 29 and 30 each have substantially the same configuration as the washer 28, the description will omit their explanation.

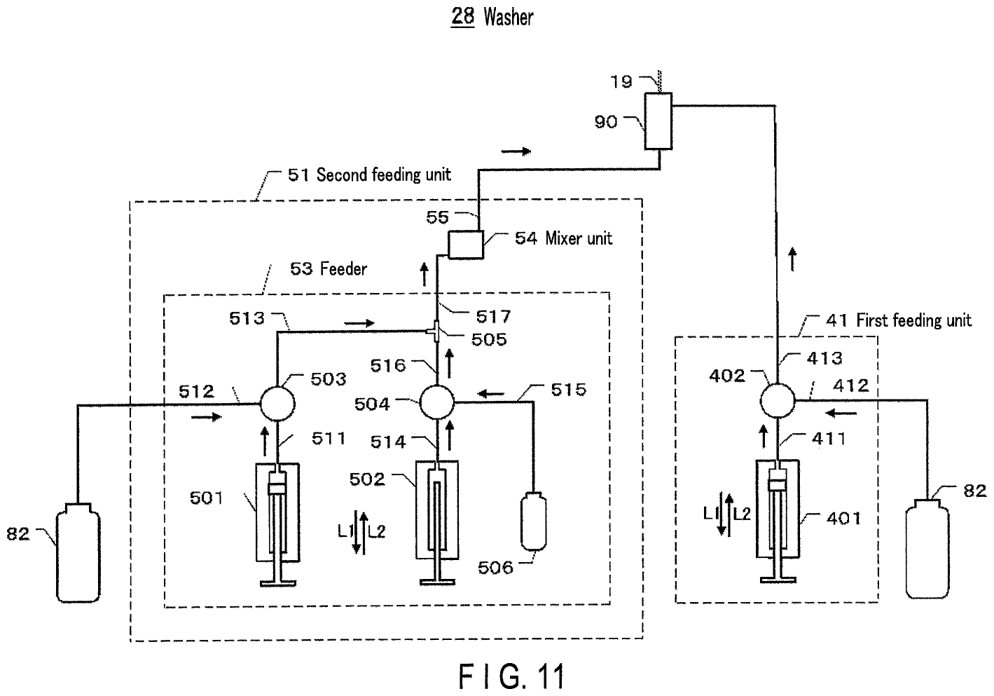

FIG. 11 shows an exemplary configuration of the washer 28. For the components of the washer 28 which are substantially the same as the respective components of the first feeding unit 41 shown in FIG. 4 and the second feeding unit 51 shown in FIG. 5, the description will use the same reference numbers or symbols and omit their explanations.

The washer 28 includes its first feeding unit 41 and second feeding unit 51, and also a washing bath 90 in which the sample dispensing probe 19 is washed using the first washing liquid and the second washing liquid fed from the first feeding unit 41 and the second feeding unit 51.

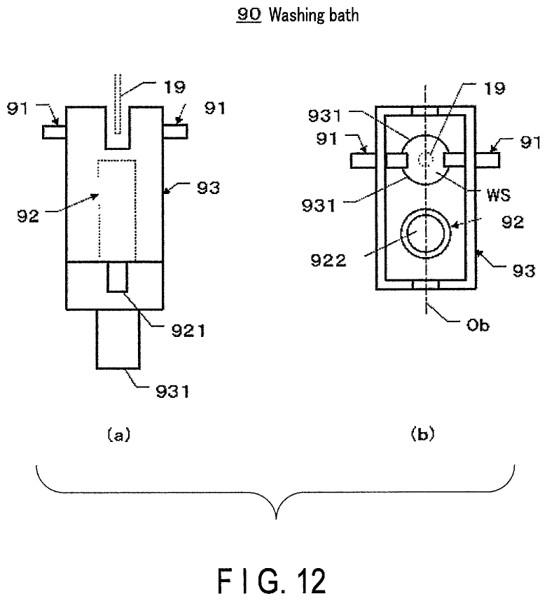

FIG. 12 shows an exemplary configuration of the washing bath 90. FIG. 12(a) is a side view of the washing bath 90, and FIG. 12(b) is a planar view of the washing bath 90. The washing bath 90 is constituted by two discharge pipes 91 for discharging the first washing liquid fed from the first feeding unit 41, a tub 92 for pooling the second washing liquid fed from the second feeding unit 51, and a bath main part 93 for supporting each of the discharge pipes 91 and the tub 92.

The two discharge pipes 91 lie down and face each other with a trajectory Ob of the sample dispensing probe 19 interposed between them. Along this trajectory Ob, the sample dispensing probe 19 makes a horizontal movement between a given position above the sample container 11 held by the sample rack 12 and a given position above the reaction container 17 held by the reaction disk 18.

While not illustrated in the drawing, the washing bath 90 includes a three-way branch pipe and two tubes. The first port of this three-way branch pipe is connected to the tube 413 of the first feeding unit 41. In the washing bath 90, the second port of the three-way branch pipe is connected to one of the discharge pipes 91, and the third port of the three-way branch pipe is connected to the other one of the discharge pipes 91.

The tub 92 is located below the trajectory Ob, and includes a liquid receiving portion 921 into which the second washing liquid fed from the second feeding unit 51 is introduced, and a liquid receiving chamber 922 where the second washing liquid overflown from the liquid receiving portion 921 is kept.

The bath main part 93 includes a drain pipe 931 for draining the first washing liquid and the second washing liquid that have been used for washing the sample dispensing probe 19.

The two discharge pipes 91 each discharge the first washing liquid fed from the first feeding unit 41, toward the sample dispensing probe 19 stopped at a washing position WS set between the discharge pipes 91. The discharge of the first washing liquid here may aim at the portion of the sample dispensing probe 19 which contacted the sample. In this manner, the outer part of the sample dispensing probe 19 that was in contact with the sample is washed.

To undergo washing with the second washing liquid, the sample dispensing probe 19 is moved along the trajectory Ob to a position above the tub 92, before aspirating a sample from the sample container 11 or after discharging a sample to the reaction container 17. The sample dispensing probe 19 is caused to descend to a level where its outer part for contacting the sample reaches the second washing liquid in the liquid receiving chamber 922. The sample dispensing probe 19 aspirates the second washing liquid. Subsequently, the sample dispensing probe 19 is caused to ascend and is moved to the washing position WS, where it discards the second washing liquid aspirated from the tub 92. After the sample dispensing probe 19 discards the second washing liquid, the discharge pipes 91 each discharge the first washing liquid toward the sample dispensing probe 19 at the washing position WS. The discharge of the first washing liquid here may aim at the outer part of the sample dispensing probe 19 which contacted the second washing liquid in the tub 92. In this manner, the second washing liquid attached to the outer part of the sample dispensing probe 19 is washed out, and the washing of the sample dispensing probe 19 with the second washing liquid comes to an end.

The washer 29 is adapted to wash the first reagent dispensing probe 21 in a similar manner to the washer 28 washing the sample dispensing probe 19, and therefore, the explanation of the washer 29 will be omitted. Also, the washer 30 is adapted to wash the second reagent dispensing probe 23 in a similar manner to the washer 28 washing the sample dispensing probe 19, and therefore, the explanation of the washer 30 will be omitted.

Note that the washer 28, etc. are not limited to the configurations described above for the exemplary embodiments. For example, the washer 28 may further include the third feeding unit 61 and the washing bath 90 may additionally include a tub for pooling the third washing liquid fed from the third feeding unit 61, so that the sample dispensing probe 19 undergoes washing steps with the respective first to third washing liquids.

Providing the mixer unit 54 here enables strong mixing of the first liquid and the second liquid, which allows for preparation of the second washing liquid with a constant concentration of the detergent component. Moreover, feeding the second washing liquid prepared at the mixer unit 54 to the tub 92 can realize avoiding the degradation of analysis data that could result from a poor capability to wash the sample dispensing probe 19 due to the washing liquid having a reduced detergent component concentration, or the degradation of analysis data that could result from the detergent component remaining on the sample dispensing probe 19 due to the washing liquid having an increased detergent component concentration.

According to the foregoing embodiments, the mixer unit 54 is provided between the feeder 53 and the second discharge nozzle 52. The mixer unit 54 is constituted by the inflow part 521, the main part 522 with the internal space 5221, and the outflow part 523. A mixture of the first liquid and the second liquid is caused to flow into the internal space 5221 from the opening at the end of the channel in the inflow part 521. Here, the cross-sectional area of the internal space 5221, which is normal to the central axis of the channel in the inflow part 521, is larger than the cross-sectional area of the tube 517 serving as a multi-liquid channel. Also, said end of the channel in the inflow part 521 (i.e., the opening at said end) has a cross-sectional area smaller than the cross-sectional area of the tube 517 serving as a multi-liquid channel. Accordingly, the mixture of the first liquid and the second liquid flows through the channel in the inflow part 521 at a higher velocity than the velocity of the flow within the tube 517 and enters the internal space 5221 in a radial fashion.

The first liquid and the second liquid already present in the internal space 5221 are mixed by the first liquid and the second liquid introduced from the inflow part 521. The first liquid and the second liquid already present in the internal space 5221 are thus caused to flow together with the introduced first and second liquids as an integral current, within the internal space 5221 and toward the outflow part 523. Therefore, the first liquid and the second liquid are more strongly mixed with each other than in the case of being mixed only within the tube 517. This allows for the preparation of the second washing liquid with a constant concentration of the detergent component provided from the second liquid.

The second washing liquid prepared through the step of strongly mixing the first liquid and the second liquid with the mixer unit 54 is then discharged from the second discharge nozzle 52. Therefore, it is possible to avoid the degradation of analysis data that could result from a poor capability to wash the reaction container 17 due to the washing liquid having a reduced detergent component concentration, or the degradation of analysis data that could result from the detergent component remaining in the reaction container 17 due to the washing liquid having an increased detergent component concentration.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

What is claimed is:

1. An automatic analyzing apparatus comprising:
a feeder configured to feed a first liquid and a second liquid; and
a mixer unit comprising an inflow part, an internal space, and an outflow part, the mixer unit being configured so that
the first liquid and the second liquid fed from the feeder enter through the inflow part,
the first liquid and the second liquid entering through the inflow part flow inside the internal space, and
the first liquid and the second liquid flowing inside the internal space exit through the outflow part according to an inflow entering through the inflow part.

2. The automatic analyzing apparatus according to claim 1, wherein
the feeder is configured to intermittently feed the first liquid and the second liquid to the mixer unit, and
the internal space has a volumetric capacity larger than a total amount of the first liquid and the second liquid fed by the feeder at one time.

3. The automatic analyzing apparatus according to claim 1, wherein
the feeder comprises a first feeding pump configured to eject the first liquid, a second feeding pump configured to eject the second liquid, a first-liquid channel for the first liquid to flow according to an ejecting action of the first feeding pump, a second-liquid channel for the second liquid to flow according to an ejecting action of the second feeding pump, and a multi-liquid channel for the first liquid from the first-liquid channel and the second liquid from the second-liquid channel to flow together, and
the feeder is configured to feed the first liquid and the second liquid to the mixer unit via the multi-liquid channel.

4. The automatic analyzing apparatus according to claim 3, wherein a cross-sectional area of the internal space, which is normal to a central axis of a channel in the inflow part for the first liquid and the second liquid to flow, is larger than a cross-sectional area of the multi-liquid channel.

5. The automatic analyzing apparatus according to claim 3, wherein a cross-sectional area of an opening at an end of a channel in the inflow part, from which the first liquid and the second liquid flow into the internal space, is smaller than a cross-sectional area of the multi-liquid channel.

6. The automatic analyzing apparatus according to claim 2, further comprising
a reaction container adapted to contain a sample and a reagent, and
a nozzle configured to discharge, according to each feeding operation of the feeder, said total amount of the first liquid and the second liquid exiting through the outflow part, to the reaction container from which the sample and the reagent have been drained.

7. The automatic analyzing apparatus according to claim 2, further comprising
a probe configured to aspirate and discharge a sample or a reagent, and
a tub adapted to pool the first liquid and the second liquid exiting through the outflow part, according to each feeding operation of the feeder,
wherein the probe is configured to aspirate the first liquid and the second liquid pooled in the tub, before aspirating the sample or the reagent or after discharging the sample or the reagent.

8. The automatic analyzing apparatus according to claim 1, wherein an amount of the second liquid is smaller than an amount of the first liquid among the first liquid and the second liquid fed by the feeder.

9. The automatic analyzing apparatus according to claim 1, wherein the first liquid is a diluent for the second liquid.

10. The automatic analyzing apparatus according to claim 8, wherein the second liquid is an alkaline or acidic liquid.
